(19) United States
(12) Patent Application Publication
(10) Pub. No.: US 2026/0353016 A1
(43) Pub. Date: Nov. 5, 2026

(54) ELECTROACOUSTIC PLASMA TRANSDUCER SYSTEM

(71) Applicant: SONEXOS SA, Lausanne (CH)

(72) Inventors: Mark Donaldson, Lausanne (CH); Stanislav Sergeev, Lausanne (CH); Hervé Lissek, Lausanne (CH)

(21) Appl. No.: 19/486,492

(22) PCT Filed: May 15, 2024
(86) PCT No.: PCT/EP2024/063410

§ 371 Date: Nov. 21, 2025

(30) Foreign Application Priority Data
May 25, 2023 (GB) 2307872.8

(51) Int. Cl. H04R 23/00; G10K 11/178; H04R 1/02; H04R 1/28

(52) U.S. Cl. CPC H04R 23/002; G10K 11/1785; H04R 1/025; H04R 1/2811; G10K 2210/3229

(57) ABSTRACT

An electroacoustic plasma transducer system includes electroacoustic plasma transducer apparatus including a plasma electrode arrangement including a corona electrode and a collector electrode separated from the corona electrode by an air gap; a peripheral support operative to support the plasma electrode arrangement, the peripheral support being electrically insulative; and an enclosure defining a chamber for receiving rearward radiation from the plasma electrode arrangement; and drive means operative to supply a voltage between the corona electrode and the collector electrode. The plasma electrode arrangement is configured such that: a central active area of the corona electrode is spaced from the collector electrode by a distance d; and a periphery of the corona electrode is spaced from the collector electrode and/or peripheral support such that for any path from the corona electrode to the collector electrode via the peripheral support (150), the path has a path length c, in which c≥1.085d.

The present invention relates to an electroacoustic plasma transducer system, and, particularly, but not exclusively, an electroacoustic plasma transducer system for use as part of an active noise reduction (ANR) system employing acoustic impedance control.

Active noise reduction is a technique that aims to reduce unwanted sound either at a specific control location or globally within a space. It uses acoustic sensing means to sense the unwanted sound or sound field, a controller to derive one or more control signals, and one or more electroacoustic drivers (e.g. loudspeakers or earphone drivers) to reproduce the control signals as one or more controlling sounds. Active noise reduction can be implemented using active noise cancellation, which is based on the principle of destructive interference of signals, or active acoustic impedance control. The former has been widely adopted in commercial applications, such as active noise-cancelling earphones, whereas the latter has seen limited use due to the performance limitations of available transducers.

Electrodynamic loudspeakers are widely used for active noise reduction due to their simplicity and affordability. They typically comprise a diaphragm suspended in a mounting structure and are driven by an electromagnetic force generated between a permanent magnet, installed in said supporting structure, and a coil attached to the diaphragm.

The acoustic response of a dynamic loudspeaker can be represented by a single-degree-of-freedom resonator. This resonator is controlled by its compliance and mass at the frequencies below and above its resonance frequency respectively. That is, the transducer is non-ideal with its inertia reducing the sharpness of its acoustic response.

Reducing a dynamic loudspeaker diaphragm's mass is thus a desired design objective, but this can be challenging, especially in applications requiring high acoustic source strength and durability. Furthermore, mitigating the mass-induced performance limitations of the dynamic loudspeaker's diaphragm through the application of active control methods can add to the complexity of the connected controller, reducing the overall system's robustness and increasing the possibility of instability.

Accordingly, there is a need for an alternative transducer technology for active noise reduction applications which operates without the limitations imposed by mass and compliance.

An atmospheric corona discharge-based loudspeaker can produce audible sound if the high voltage across its corona electrode (being that electrode around which ionization of air particles occurs) and collector electrode (being that electrode to which ionized air particles are attracted) is modulated at audible frequencies. This modulation changes the mechanical energy transferred from charged particles to the neutral air, resulting in the propagation of sound waves. While prior art corona discharge loudspeakers can produce sound over an extended surface, they are not well-suited for active noise reduction applications as they are not optimised to produce the controlling sound over a particular frequency range important in active noise reduction applications.

Additionally, prior art corona discharge transducers are prone to arcing, limiting the voltage difference that can be supplied to produce sound and thus their sound-producing capabilities. They also generate ozone, which can be harmful in high concentrations.

These issues associated with prior art must be addressed for the successful implementation of a corona discharge-based transducer in active noise reduction applications.

The present applicant has identified the need for a new electroacoustic plasma transducer apparatus to address or at least alleviate problems associated with the prior art.

In accordance with a first aspect of the present invention, there is provided an electroacoustic plasma transducer system comprising: electroacoustic plasma transducer apparatus comprising: a plasma electrode arrangement including a corona electrode and a collector electrode separated from the corona electrode by an air gap; a peripheral support (e.g. frame) operative to support the plasma electrode arrangement (e.g. mechanically couple the collector electrode to the corona electrode), the peripheral support being electrically insulative; an enclosure defining a chamber for receiving rearward radiation from the plasma electrode arrangement; and drive means (e.g. drive circuit) operative to supply a voltage U(t) between the corona electrode and the collector electrode of the electroacoustic plasma transducer apparatus.

In one embodiment, the plasma electrode arrangement of the plasma transducer apparatus is configured such that: a central active area of the corona electrode is spaced from the collector electrode by a distance d; and a periphery of the corona electrode (e.g. substantially the full periphery) is spaced from the collector electrode and/or peripheral support such that for any path from the corona electrode to the collector electrode via the peripheral support, the path has a path length c, wherein c≥1.085d.

In this way, an electroacoustic plasma transducer system is provided that allows the level of sound output generated by the plasma electrode to be maximised whilst minimising undesirable heating of/damage to the electrically insulating support material.

In one embodiment, 1.085 d≤c≤2 d.

In one embodiment, d=2-10 mm.

In one embodiment, the drive means is operative to supply a constant bias voltage component U_{DC} and a time-varying alternating component U_{AC}(t), wherein the voltage difference applied to plasma electrode arrangement U(t)=U_{DC}+U_{AC}(t).

In one embodiment, the drive means is operative to maintain a voltage difference range U(t)_{range} between the corona electrode and collector electrode when in an operative (i.e. plasma generating) mode, wherein U(t)_{range}=(0.35−0.85)×E_{breakdown}×d, wherein E_{breakdown}=3×10⁶ V/m.

In one embodiment, the drive means is operative at maximum acoustic output of the electroacoustic plasma transducer apparatus to supply a voltage difference Uₘₐₓ between the corona electrode and collector electrode, wherein Uₘₐₓ≥0.65×E_{breakdown}×d, wherein E_{breakdown}=3×10⁶ V/m.

In one embodiment, the plasma electrode arrangement defines a longitudinal axis along which the corona electrode and collector electrode are spaced (e.g. with the collector electrode forming the front or outer electrode and the corona electrode forming the rear or inner electrode).

In one embodiment, at least one of the corona electrode and the collector electrode is spaced from the peripheral support along an axis transverse to the longitudinal axis by a distance b satisfying the requirement for c.

In one embodiment, at least one of the corona electrode and the collector electrode have longitudinally extending inclined end profiles (e.g. inclined panel/wire/rod end sections) whereby spacing between the corona electrode and the collector electrode at the region where the plasma electrode arrangement meets the peripheral support satisfies the requirement c (e.g. with spacing (e.g. longitudinal spacing) between the corona electrode and the collector electrode at the region where the plasma electrode arrangement meets the peripheral support is >d and within the parameter c).

In one embodiment, the longitudinally extending inclined end profiles define a curved (e.g. convex curved) air gap facing surface.

In one embodiment, the collector electrode is a panel-form (e.g. grid or lattice) collector electrode (e.g. a foraminous (e.g. perforated) plate or a grid) coupled to the peripheral support.

In another embodiment, the corona electrode comprises a plurality of (e.g. laterally spaced) elongate corona electrode members (e.g. wires or rods) coupled to the peripheral support.

In one embodiment, the plurality of elongate corona electrode members each substantially extend along a first transverse axis of the plasma electrode arrangement (e.g. substantially perpendicular to the longitudinal axis).

In one embodiment, the elongate corona electrode members are longitudinally spaced from the collector electrode by distance d.

In one embodiment, the plurality of elongate corona electrode members extend substantially parallel to one another.

In one embodiment, the elongate corona electrode members are laterally spaced from one another by a distance a.

In one embodiment, the corona electrode (e.g. panel-form corona electrode or each of the plurality of elongate corona electrode members) supports at least one projecting portion projecting along the longitudinal axis towards the collector electrode (i.e. with a tip or leading edge of the at least one projecting portion forming the central active areas of the corona electrode).

In one embodiment, the at least one projecting portion is spaced from the peripheral support (e.g. along the first transverse axis).

In one embodiment, the at least one projecting portion comprises a plurality of longitudinally extending projections (e.g. pins) spaced along the first transverse axis.

In one embodiment, the at least one projecting portion comprises a longitudinally extending elongate blade (e.g. elongate in the first transverse axis).

In one embodiment, the at least one projecting portion is spaced from the peripheral support relative the first transverse axis by a minimum distance b.

In one embodiment, the at least one projection has a tapered profile defining a leading surface (e.g. tip) that is spaced from the support relative the first transverse axis by the minimum distance b.

In one embodiment, b=0.45 d.

In one embodiment, the elongate corona electrode members have longitudinally extending inclined end profiles (e.g. inclined wire/rod end sections) whereby spacing between the elongate corona electrode members and the collector electrode at the region where the elongate corona electrode members meet the peripheral support satisfies the requirement c.

In one embodiment, the longitudinally extending inclined end profiles define a curved (e.g. convex curved) air gap facing surface.

In one embodiment, the elongate corona electrode members provided closest to the peripheral support (e.g. first and last elongate corona electrodes as spaced along the second transverse axis) are spaced laterally from the peripheral support by a distance b.

In one embodiment, the collector electrode is substantially planar.

In one embodiment, the collector electrode is a panel-form (e.g. grid or lattice) collector electrode (e.g. a foraminous (e.g. perforated) plate or a grid).

In one embodiment, the collector electrode comprises a plurality of elongate collector electrode members (e.g. rods) coupled to the peripheral support.

In one embodiment, the plurality of elongate collector electrode members substantially extend along the first transverse axis of the plasma electrode arrangement or along a second transverse axis of the plasma electrode arrangement (e.g. substantially perpendicular to the first transverse axis).

In one embodiment, the plurality of elongate collector electrode members extend substantially parallel to one another.

In one embodiment, the elongate collector electrode members are spaced from one another by a distance a′.

In one embodiment, a′=a.

In one embodiment, the elongate collector electrode members each have longitudinally extending inclined end profiles (e.g. inclined rod end sections) whereby spacing between the elongate collector electrode members and the corona electrode at the region where the elongate collector electrode members meet the peripheral support satisfies the requirement c.

In one embodiment, the longitudinally extending inclined end profiles define a curved (e.g. convex curved) air gap facing surface. In one embodiment, 0.8 d≤a≤3 d.

In one embodiment, 0.8 d≤a′≤3 d.

In one embodiment, b=a/2 (e.g. a/4≤b≤3a/4)

In one embodiment, the elongate corona electrode members have an effective diameter in the range 100-1000 μm.

In one embodiment, the plasma electrode arrangement is substantially transparent to the propagation of sound waves (e.g. to be effective in the delivery of active noise reduction). In one embodiment, the plasma electrode arrangement has an acoustic power transmission coefficient of not less than 80% over a frequency range 0-5000 Hz.

In one embodiment, the plasma electrode arrangement has an acoustic power reflection coefficient no higher than 10% over a frequency range 0-5000 Hz.

With lower transmission rates the plasma transducer has a diminished performance to interact with the external acoustic field. With a higher reflection coefficient, the plasma transducer's acoustic response can cause unstable behaviour of the controlled system.

In one embodiment, the enclosure is a substantially sealed enclosure.

In one embodiment, the enclosure is a vented enclosure.

In one embodiment, the chamber has a longitudinal length l.

In one embodiment l is less than 20 mm.

In one embodiment, the electroacoustic plasma transducer apparatus further comprises acoustic response tuning means (e.g. acoustic response tuning structure) provided in or as part of the enclosure.

In one embodiment, the acoustic response tuning means comprises an acoustically absorbent structure (e.g. formed from porous or granular material) provided in the chamber. The acoustically absorbent structure may be operative to absorb sound above a low-frequency threshold (e.g. above around 300 Hz).

In one embodiment, the acoustic response tuning means comprises passive resonator means (e.g. a passive resonator such as a Helmholtz resonator, membrane-based resonator or passive radiator (e.g. formed in a rear wall of the enclosure)). The passive resonator means may be operative to absorb sound at low frequency (e.g. under around 300 Hz).

In one embodiment, the acoustic response tuning means comprises a combination of an acoustically absorbent structure and a passive resonator.

In one embodiment, the acoustic response tuning means may be disposed in one or more walls of the chamber.

In one embodiment, the acoustically absorbent structure may include any one or more acoustic absorbing materials such as activated carbon, wool, or fibres, and/or foams.

In one embodiment, the acoustic response tuning means comprise a hole of particular diameter covered by a porous paper or foam exhibiting a specified acoustic resistivity.

In one embodiment, the peripheral support is formed from an electrically insulating ceramic or a plastic polymer.

In accordance with a second aspect of the present invention, there is provided an electroacoustic plasma transducer system comprising: electroacoustic plasma transducer apparatus comprising: a plasma electrode arrangement including an inner electrode (e.g. corona electrode) and an outer electrode (e.g. collector electrode) separated from the inner electrode by an air gap; a peripheral support (e.g. frame) operative to support the plasma electrode arrangement (e.g. mechanically couple the collector electrode to the corona electrode); and an enclosure defining a chamber for receiving rearward radiation from the plasma electrode arrangement; and drive means (e.g. drive circuit) operative to supply a voltage U(t) between the corona electrode and the collector electrode of the electroacoustic plasma transducer apparatus; wherein the apparatus further comprises an ozone reducing material (e.g. ozone reducing catalyst).

In this way, an electroacoustic plasma transducer system is provided that provides improved sound production means for active noise reduction with the elimination of undesirable ozone.

In one embodiment, the ozone reducing material comprises manganese (e.g. manganese oxide-based catalyst).

In one embodiment, the electroacoustic plasma transducer apparatus comprises a porous structure and the ozone reducing material is provided on (e.g. within or applied as a coating to) the porous structure.

In one embodiment, the plasma electrode arrangement defines a longitudinal axis along which the inner and outer electrodes are spaced. In one embodiment, the collector electrode forms the outer electrode and the corona electrode forms the inner electrode.

In one embodiment, the porous structure comprises a foraminous plate (e.g. perforated plate) or a mesh structure.

In one embodiment, the porous structure comprises an outer ozone filter provided in front of the plasma electrode arrangement (e.g. whereby forward airflow from the plasma electrode arrangement passes through the outer zone filter before exiting the electroacoustic plasma transducer apparatus).

In one embodiment, the outer ozone filter has a thickness of less than 15 mm.

In one embodiment, the outer ozone filter is longitudinally spaced from the collector electrode by up to 10 mm.

In one embodiment, the outer ozone filter abuts the outer electrode of the plasma electrode arrangement (e.g. abuts the outer electrode).

In one embodiment, the outer ozone filter is incorporated into at least one electrode of the plasma electrode arrangement (e.g. incorporated into the outer electrode).

In one embodiment, the ozone reducing material is incorporated into the outer electrode (e.g. into the collector electrode).

In one embodiment, the outer electrode (e.g. collector electrode) defines an inner face facing the inner electrode (e.g. corona electrode), an outer face substantially opposed to the inner face, and internal surfaces defined by apertures in the outer electrode.

In one embodiment, the ozone reducing material is applied to the internal surfaces of the outer electrode and/or the outer face of the outer electrode.

In one embodiment, the ozone reducing material is substantially not applied to the inner face of the outer electrode.

In one embodiment, the outer electrode (e.g. collector electrode) is removably coupled to the peripheral support (e.g. with suitable electrical connections provided to allow the outer electrode to be electrically disconnected).

In one embodiment, the outer ozone filter has an average effective aperture diameter of between 0.1-2 mm.

In one embodiment, the outer ozone filter has an aperture density of greater than 30 apertures per cm².

In one embodiment, the outer ozone filter is acoustically sealed around a peripheral edge of the plasma electrode arrangement.

In one embodiment, the outer ozone filter is configured to achieve a certain acoustic response.

In one embodiment, the outer ozone filter is configured (e.g. its acoustic response is tuned) to have an acoustic power transmission coefficient greater than 50% in the frequency range 0-5000 Hz.

In one embodiment, the outer ozone filter is configured (e.g. its acoustic response is tuned) to have an acoustic power reflection coefficient no higher than 10% over a frequency range 0-5000 Hz.

In one embodiment, the acoustic response of the outer ozone filter is configured to ensure that the outer ozone filter does not reduce the produced controlling sound level by more than 3 dB at 5000 Hz.

In one embodiment, the porous structure (e.g. outer ozone filter) comprises a honeycomb structure formed from a clay ceramic, or a mesh, a grid or a perforated structure.

In one embodiment, the outer ozone filter is sealed to the front of the plasma electrode arrangement using a compliant adhesive or suspension.

In one embodiment, the enclosure is a substantially sealed enclosure.

In one embodiment, the ozone reducing material is provided within the enclosure (e.g. in or on walls of enclosure and/or in or on a porous structure provided within the chamber).

In one embodiment, the electroacoustic plasma transducer apparatus further comprises an airflow blocking screen (e.g. airflow suppression screen) provided in front of the plasma electrode arrangement (e.g. in front of the outer electrode), wherein the airflow blocking screen is operative to substantially allow transmission of acoustic pressure waves but substantially prevent transmission of airflow.

In one embodiment, the airflow blocking screen is formed from a porous sheet material (e.g. wire mesh or textile material).

In one embodiment, the airflow blocking screen has a longitudinal thickness of less than 5 mm.

In one embodiment, the porous structure is provided within the chamber.

In one embodiment, the porous structure is an acoustically absorbent structure.

In one embodiment, the acoustically absorbent structure is a honeycomb structure with openings facing the plasma electrode arrangement (e.g. facing the inner electrode).

In one embodiment, the ozone reducing material is provided within or applied as a coating to the honeycomb structure.

In one embodiment, the peripheral support is formed from an electrically insulating ceramic or a plastic polymer.

In one embodiment, the ozone filter is a rectangular porous structure.

In one embodiment, at least 10% of a top surface area of the ozone filter is open and coated with an ozone catalyst, such as manganese, to capture ozone from air passing over it.

In a set of alternative embodiments of the invention, the ozone filter comprises a honeycomb structure formed from a clay ceramic, or a mesh, a grid or a perforated structure.

In one embodiment, the ozone filter is sealed to the front of the plasma electrode arrangement using a compliant adhesive or suspension.

In one embodiment, the plasma electrode arrangement, peripheral support and enclosure form part of a single mechanical structure.

In an alternative embodiment, the enclosure and/or ozone filter are separate parts, and may attach and detach to the plasma electrode arrangement, or a frame or structure encapsulating such using coupling means (e.g. at least one coupling device). In on embodiment, the coupling means might be mechanical, electrical, and/or magnetic.

In one embodiment, the electroacoustic plasma transducer system is an electroacoustic plasma transducer system in accordance with the first aspect of the present invention (e.g. any embodiment of the first aspect of the present invention).

In accordance with a third aspect of the present invention, there is provided an active noise reduction (ANR) system comprising: electroacoustic plasma transducer system in accordance with the first aspect of the invention (e.g. any embodiment of the first aspect of the invention) or with the second aspect of the invention (e.g. any embodiment of the second aspect of the invention); acoustic sensing means (e.g. at least one acoustic sensor); and ANR circuitry operative to receive a signal from the acoustic sensing means and control an output of the electroacoustic plasma transducer system to reduce noise.

In one embodiment, the acoustic sensing means comprises at least one sensing microphone.

In one embodiment, the ANR circuitry is operative to perform active acoustic impedance control.

In the case of electroacoustic plasma transducer apparatus including an outer structure (outer ozone filter or airflow blocking screen), the acoustic sensing means comprises an outer sensing microphone (e.g. positioned immediately in front of the outer structure) for monitoring a pressure p₁ in front of the outer structure.

In one embodiment, the acoustic sensing means comprises an inner sensing microphone for monitoring a pressure p₂ between the outer structure and the plasma electrode arrangement (e.g. between the outer structure and the front collector electrode, e.g. immediately in front of the plasma electrode arrangement).

In one embodiment, the outer structure (outer ozone filter or front airflow blocking screen, or additional acoustical screen) has an acoustic resistance (e.g. frequency dependent acoustic resistance) Res, and the part of ANR circuitry is operative to determine an estimate of acoustic velocity Vₑₛₜ, wherein

$${V}_{est} = \frac{{p}_{1} - {p}_{2}}{Res} .$$

Embodiments of the invention will now be described by way of example with reference to the accompanying drawings in which:

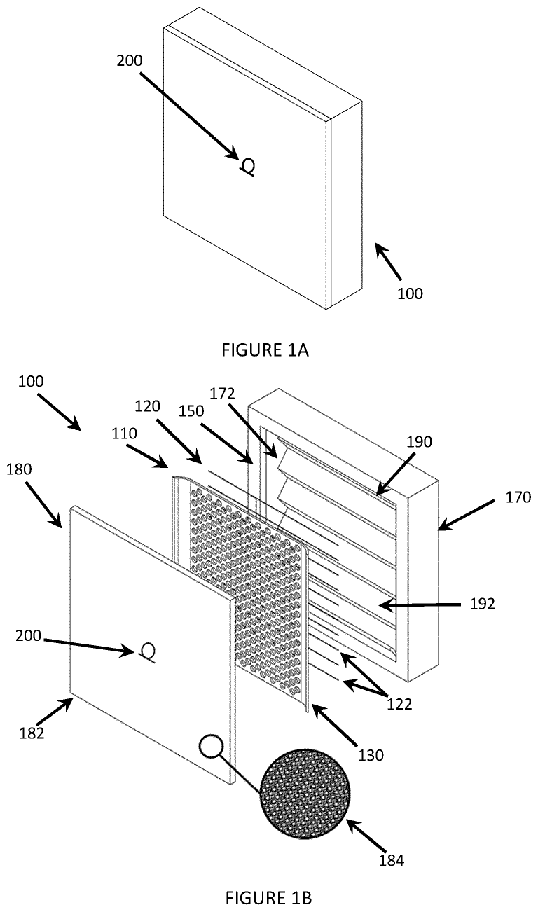

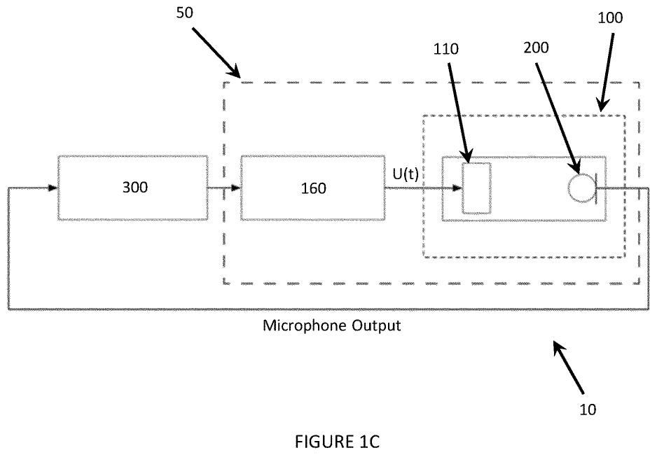

FIG. 1A is a schematic illustration of an ANR system including electroacoustic plasma transducer apparatus in accordance with a first embodiment of the present invention;

FIG. 1B is an exploded schematic view of the ANR system of FIG. 1A showing details of the electroacoustic plasma transducer apparatus;

FIG. 1C is a block diagram illustrating operation of the ANR system of FIG. 1A;

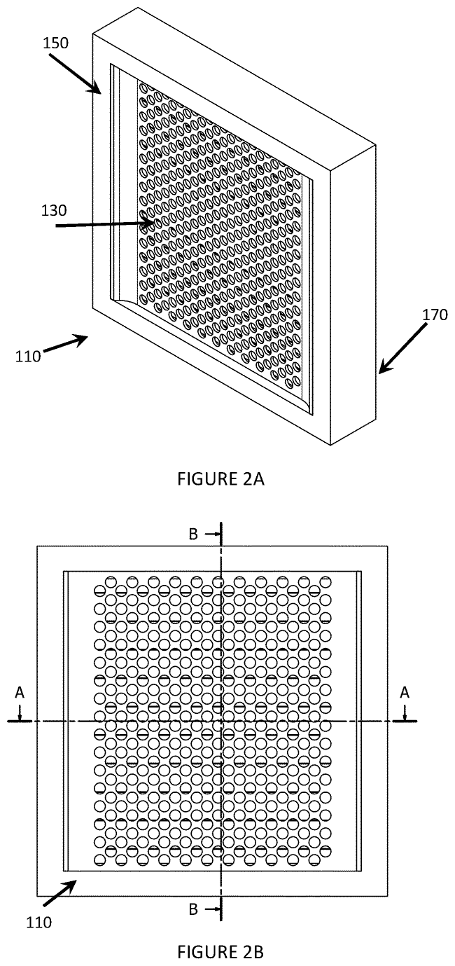

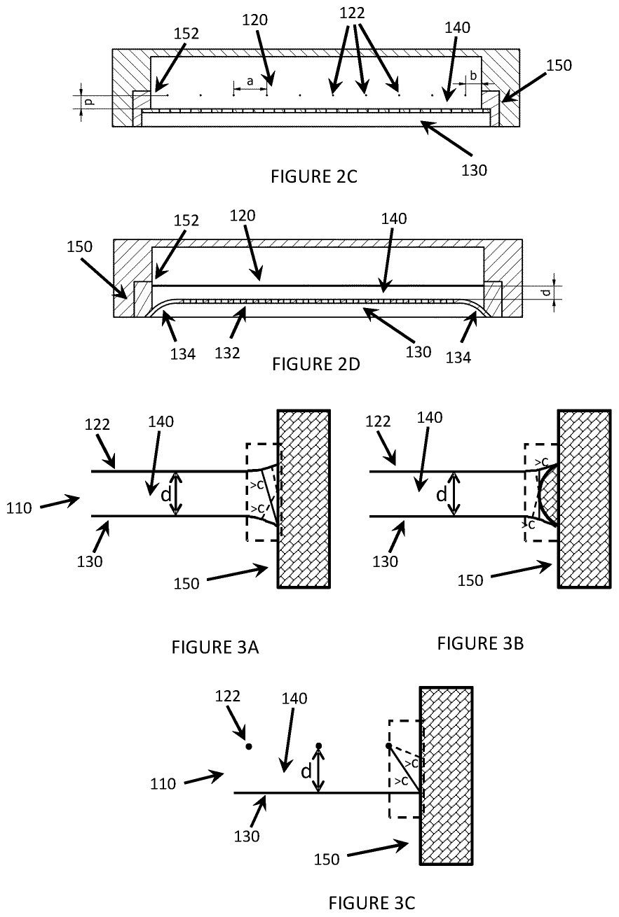

FIGS. 2A and 2B are schematic views of the electroacoustic plasma transducer apparatus of FIG. 1B;

FIG. 2C is a schematic cross-sectional view BB of FIG. 2B;

FIG. 2D is a schematic cross-sectional view AA of FIG. 2B;

FIGS. 3A-C illustrate the principle of minimum path separation at the periphery of the plasma transducer apparatus geometry design;

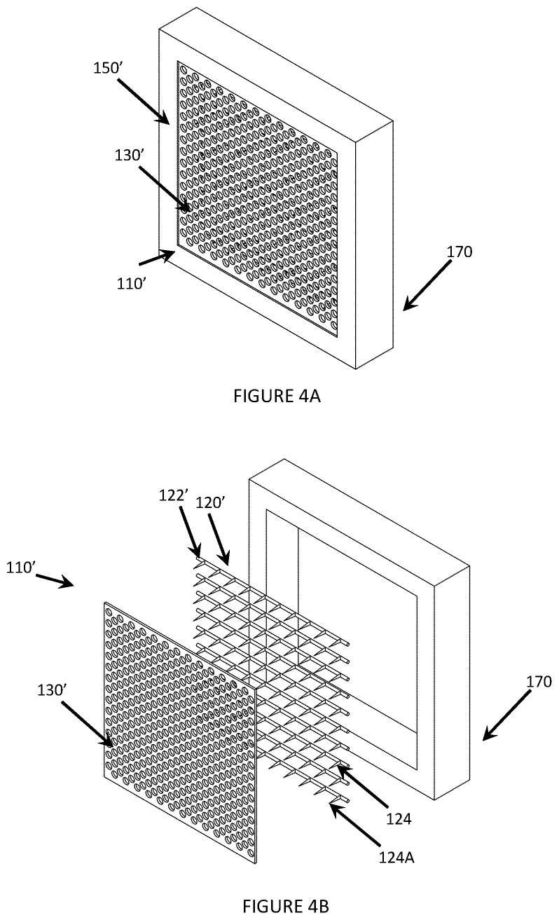

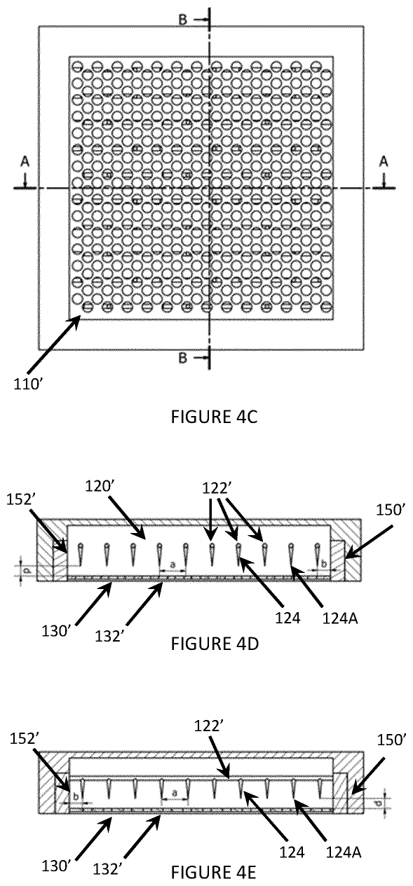

FIG. 4A is a schematic view of electroacoustic plasma transducer apparatus in accordance with a second embodiment of the present invention for use in the ANR system of FIG. 1A;

FIG. 4B is an exploded schematic view of the electroacoustic plasma transducer apparatus of FIG. 4A;

FIG. 4C is schematic plan view of the electroacoustic plasma transducer apparatus of FIG. 4A;

FIG. 4D is a schematic cross-sectional view BB of FIG. 4C;

FIG. 4E is a schematic cross-sectional view AA of FIG. 4C;

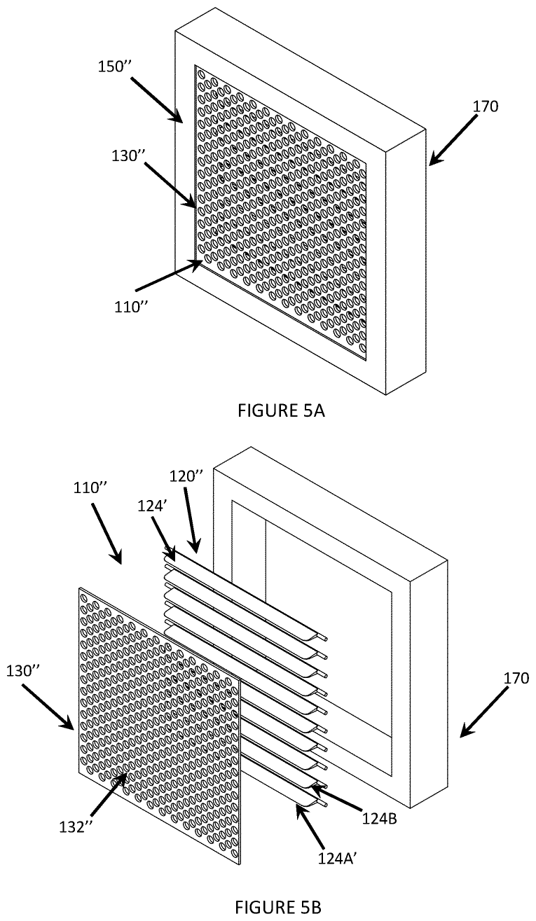

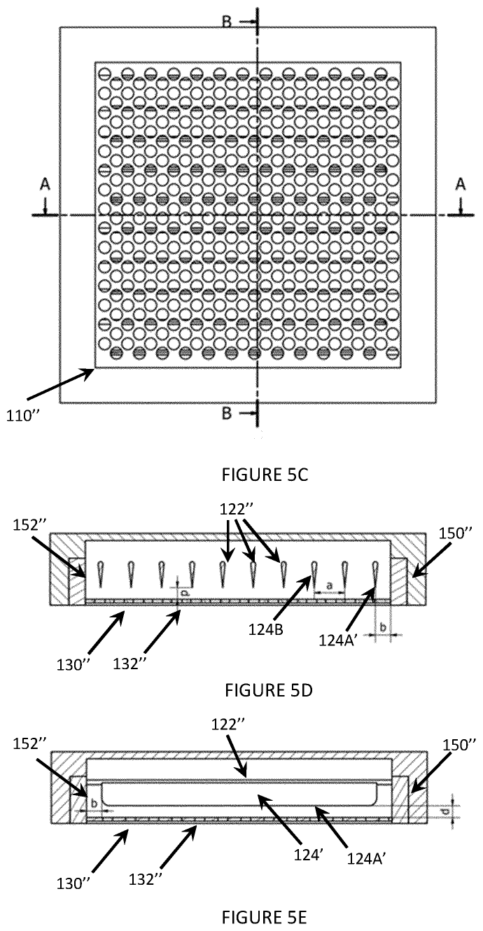

FIG. 5A is a schematic view of electroacoustic plasma transducer apparatus in accordance with a third embodiment of the present invention for use in the ANR system of

FIG. 1A;

FIG. 5B is an exploded schematic view of the electroacoustic plasma transducer apparatus of FIG. 5A;

FIG. 5C is schematic plan view of the electroacoustic plasma transducer apparatus of FIG. 5A;

FIG. 5D is a schematic cross-sectional view BB of FIG. 5C;

FIG. 5E is a schematic cross-sectional view AA of FIG. 5C;

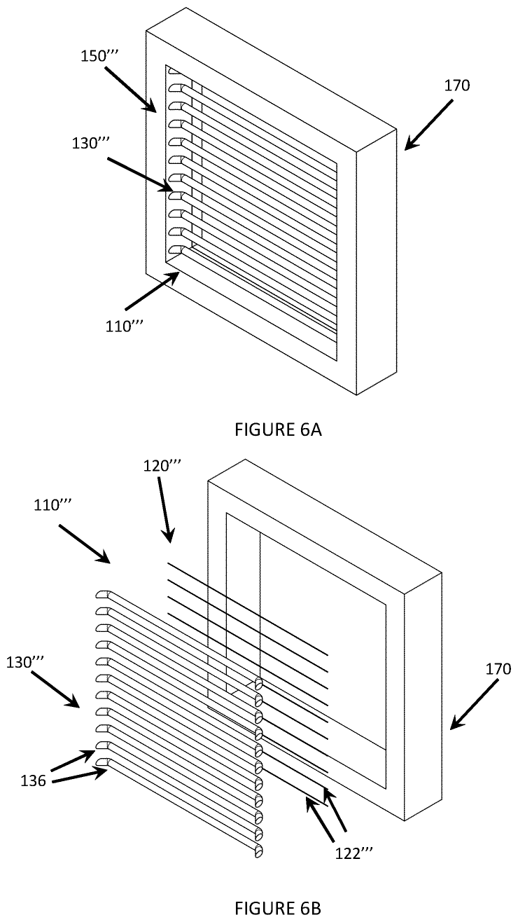

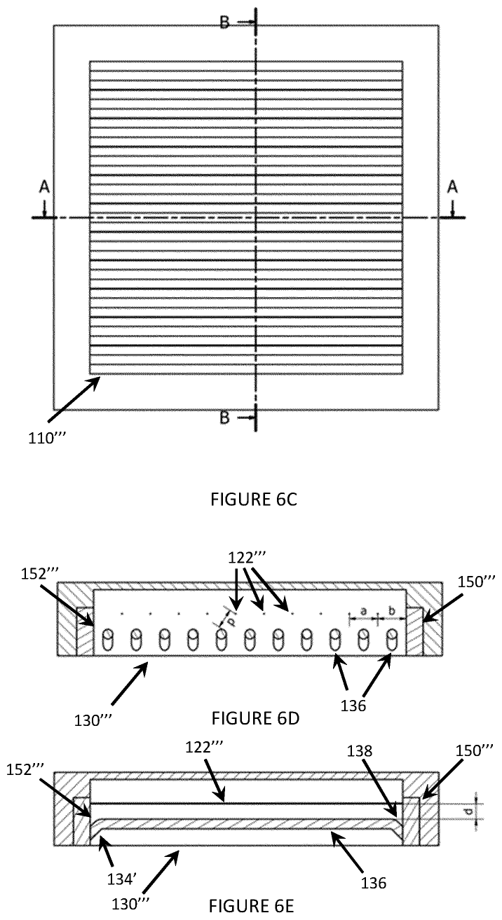

FIG. 6A is a schematic view of electroacoustic plasma transducer apparatus in accordance with a fourth embodiment of the present invention for use in the ANR system of FIG. 1A;

FIG. 6B is an exploded schematic view of the electroacoustic plasma transducer apparatus of FIG. 6A;

FIG. 6C is schematic plan view of the electroacoustic plasma transducer apparatus of FIG. 6A;

FIG. 6D is a schematic cross-sectional view BB of FIG. 6C;

FIG. 6E is a schematic cross-sectional view AA of FIG. 6C;

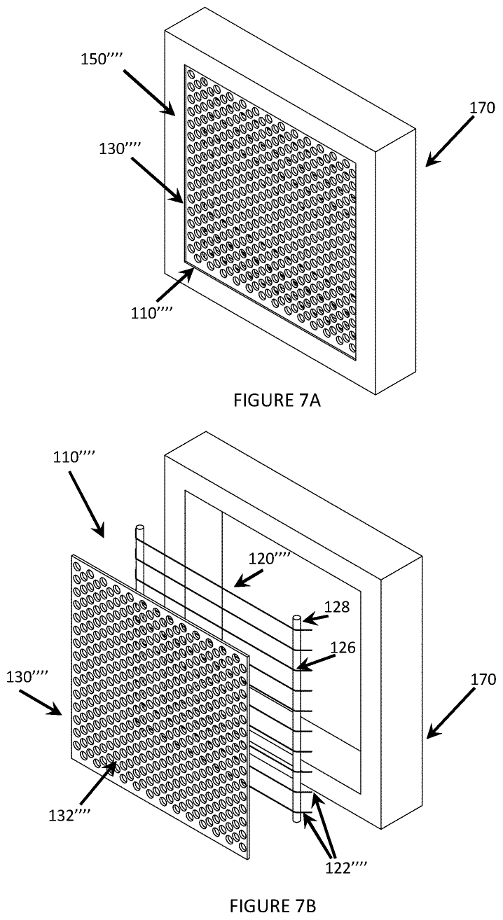

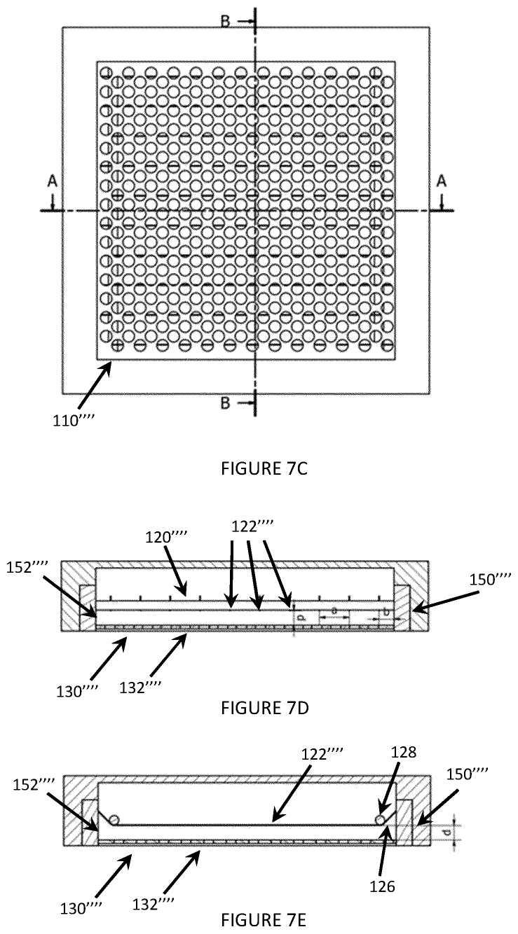

FIG. 7A is a schematic view of electroacoustic plasma transducer apparatus in accordance with a fifth embodiment of the present invention for use in the ANR system of FIG. 1A;

FIG. 7B is an exploded schematic view of the electroacoustic plasma transducer apparatus of FIG. 7A;

FIG. 7C is schematic plan view of the electroacoustic plasma transducer apparatus of FIG. 7A;

FIG. 7D is a schematic cross-sectional view BB of FIG. 7C;

FIG. 7E is a schematic cross-sectional view AA of FIG. 7C;

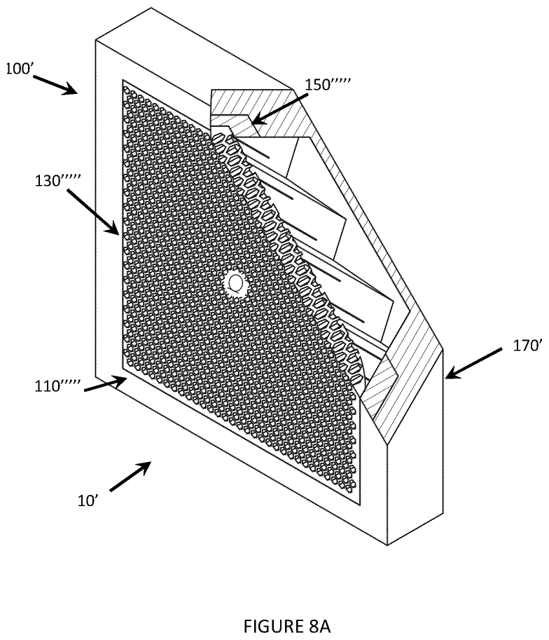

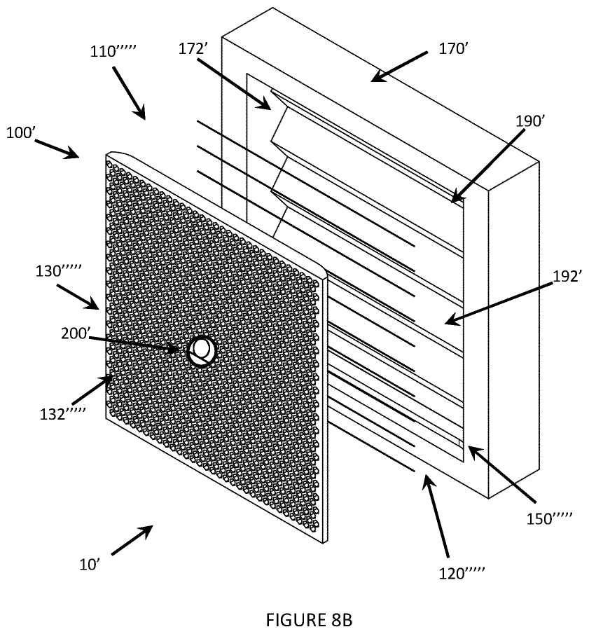

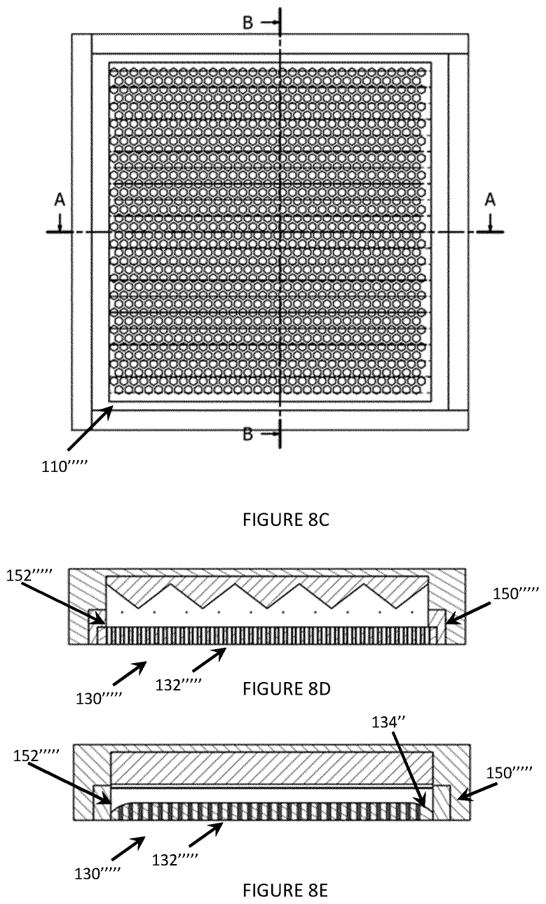

FIG. 8A is a schematic illustration of an ANR system including electroacoustic plasma transducer apparatus in accordance with a further embodiment of the present invention;

FIG. 8B is an exploded schematic view of the ANR system of FIG. 8A showing details of the electroacoustic plasma transducer apparatus;

FIG. 8C is schematic plan view of the electroacoustic plasma transducer apparatus of FIG. 8B;

FIG. 8D is a schematic cross-sectional view BB of FIG. 8C;

FIG. 8E is a schematic cross-sectional view AA of FIG. 8C;

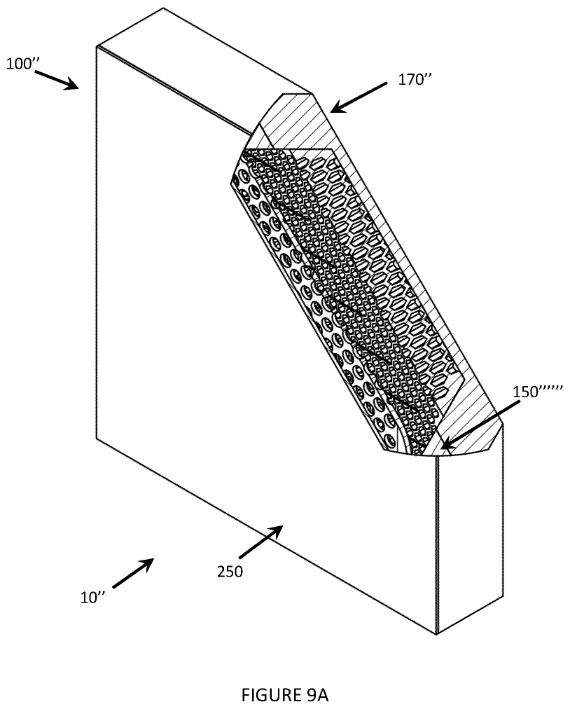

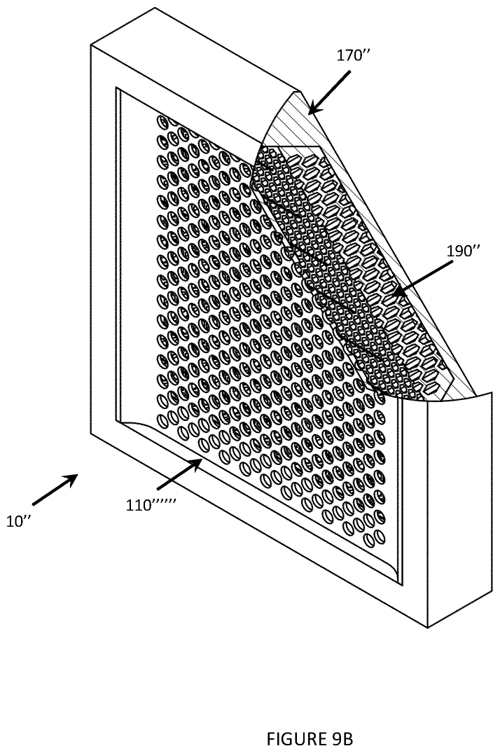

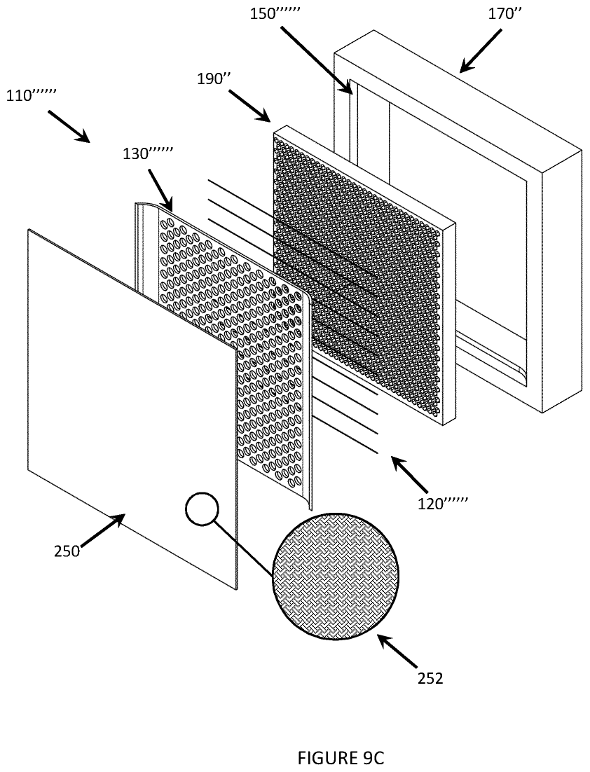

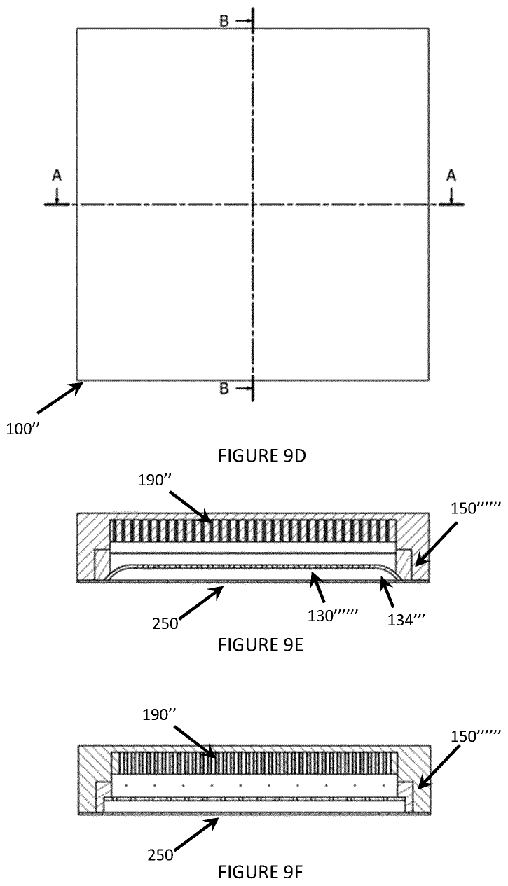

FIG. 9A is a schematic part cross-sectional illustration of an ANR system including electroacoustic plasma transducer apparatus in accordance with a yet further embodiment of the present invention;

FIG. 9B is a schematic part cross-sectional illustration of the ANR system of FIG. 9A with the front airflow blocking screen removed;

FIG. 9C is an exploded schematic view of the ANR system of FIG. 9A showing details of the electroacoustic plasma transducer apparatus;

FIG. 9D is schematic plan view of the electroacoustic plasma transducer apparatus of FIG. 9C;

FIG. 9E is a schematic cross-sectional view BB of FIG. 9D;

FIG. 9F is a schematic cross-sectional view AA of FIG. 9D;

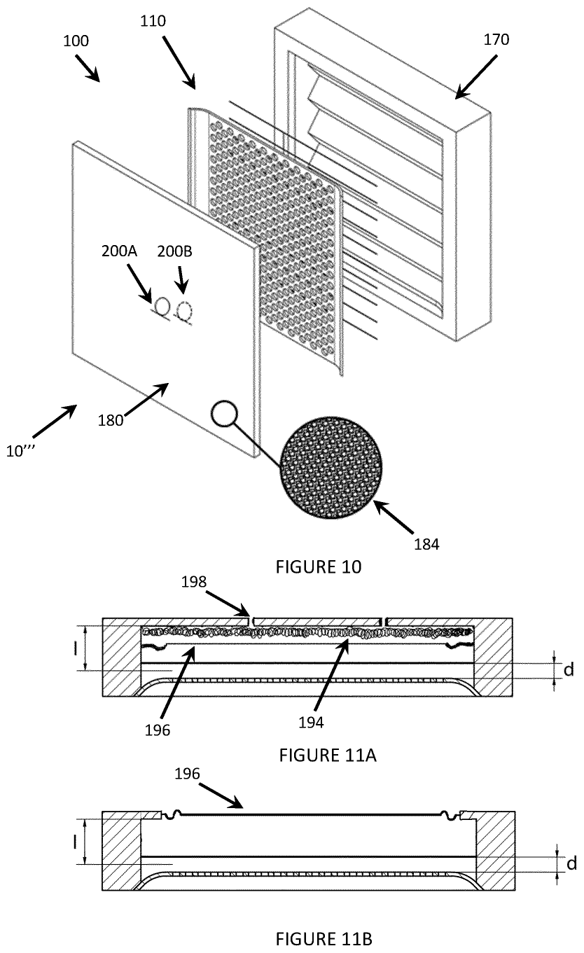

FIG. 10 is a schematic exploded schematic view of a modified version of the ANR system of FIG. 1A including inner and outer sensing microphones;

FIG. 11A is a schematic cross-sectional view of a first alternative enclosure for electroacoustic plasma transducer apparatus of FIG. 1A; and

FIG. 11B is a schematic cross-sectional view of a second alternative enclosure for electroacoustic plasma transducer apparatus of FIG. 1A.

FIGS. 1A-C show an ANR system 10 comprising: an electroacoustic plasma transducer system 50 including electroacoustic plasma transducer apparatus 100 and drive means 160; at least one sensing microphone 200; and ANR circuitry 300 operative to receive a signal from the at least one sensing microphone 200 and control an output of the electroacoustic plasma transducer system 50 to reduce noise.

As shown in FIGS. 1B and 1C, electroacoustic plasma transducer apparatus 100 comprises: a plasma electrode arrangement 110 including a corona electrode 120 and a panel-form collector electrode 130 separated from the corona electrode by an air gap 140; an electrically insulative peripheral frame 150 operative to support the plasma electrode arrangement 110; an enclosure 170; and an (optional) outer ozone filter 180 provided in front of the plasma electrode arrangement 110. As also shown, electroacoustic plasma transducer system 50 comprises drive means 160 operative to supply a voltage U(t) between corona electrode 120 and collector electrode 130.

Plasma electrode arrangement 110 defines a longitudinal axis “L” along which the corona electrode 120 and collector electrode 130 are spaced (e.g. with the collector electrode 130 forming the front or outer electrode and the higher voltage and more fragile corona electrode 120 forming the rear or inner electrode). With reference to FIG. 2B, plasma electrode arrangement 110 further defines a first transverse axis AA extending perpendicular to longitudinal axis “L” and a second transverse axis BB extending in the same plane as first transverse axis AA and perpendicular thereto.

Corona electrode 120 comprises a plurality parallel elongate corona electrode wires 122 coupled to the peripheral frame 150 at their respective ends; collector electrode 130 has a panel-form and substantially comprises a foraminous collector electrode plate 132. Corona electrode wires 122 are longitudinally spaced from collector electrode 130 by distance d and laterally spaced from one another by an equal distance a. Each corona electrode wire has an effective diameter in the range 100-1000 μm.

With reference to FIGS. 3A-C, the geometry of plasma electrode arrangement 110 is designed to satisfy the optimised condition that: a central active area of the corona electrode is spaced longitudinally from the collector electrode by a distance d; and the periphery (indicated by a dashed rectangle) of the corona electrode is spaced from the collector electrode and/or peripheral support such that for any path from the corona electrode to the collector electrode via the peripheral support, the path has a path length c, wherein 1.085d≤c≤2d.

In this example, this condition is satisfied along the second transverse axis BB by spacing the laterally outermost corona electrode wires 122 from an inner surface 152 of the peripheral frame 150 by a lateral distance b, wherein b=0.45 d.

Along the first transverse axis AA, the condition is satisfied by providing collector electrode plate 132 with curved end profiles 134′ configured such that the longitudinal distance between corona electrode wires 122 and the collector electrode 130 in the central active area of the corona electrode is d and the path between any point of corona electrode wires 122 and any point of the collector electrode 130 via the peripheral frame at the region where the corona electrode wires 122 meet the peripheral frame 150 is equal to c. As illustrated, the curvature of the curved end profiles 134 start at a lateral distance of around b from the inner 152 surface of peripheral frame 150, wherein b=0.45 d.

In use, the geometry of plasma electrode arrangement 110 allows the applied voltage U(t) to be maximised for a given value of d to achieve highly efficient operation without risk of arcing, which enables higher performance ANR.

Outer ozone filter 180 comprises a foraminous filter plate 182 with a fine aperture structure 184 (e.g. with an average effective aperture diameter of between 0.2-1 mm and an aperture density of greater than 30 apertures per cm²). An ozone reducing catalyst (e.g. manganese oxide-based catalyst) is provided on (e.g. within or applied as a coating to) the porous structure. In one embodiment, filter plate 182 is a foraminous metal plate (e.g. steel or aluminium plate) and the ozone reducing catalyst is applied as a coating to outer surfaces of the plate (e.g. including opposed inner and outer surfaces of the plate and internal surfaces of the apertures).

Outer ozone filter 180 generally has a thickness of less than 15 mm and is spaced from the central part of collector electrode 130 by a distance of at least 10 mm. Ozone filter 180 preferably has low or zero flammability.

Outer ozone filter 180 is acoustically sealed around the edge of plasma electrode arrangement 110. To avoid interfering with the controlling sound from the plasma transducer apparatus, which may include frequency components between 0-5 kHz, the filter's geometry, including its depth and perforations, is configured such that its acoustic response is tuned. Specifically, such tuning includes, but is not limited to, calibrating the geometry of the ozone filter such that its acoustic power transmission coefficient is no less than 50%, and its reflected power coefficient is no more than 10%. More generally, such tuning aims to ensure that the ozone filter does not reduce the produced controlling sound's level by more than 3 dB at 5 kHz. The ozone filter according to this description is able to capture ozone from the air while minimising its impact on the sound production of plasma transducer apparatus. Its rectangular shape and perforations, along with the use of an ozone catalyst and acoustic calibration, make it a highly efficient and precise component within the apparatus.

Enclosure 170 is a sealed enclosure and defines a chamber 172 for receiving rearward radiation from the plasma electrode arrangement 110. Chamber 172 has a longitudinal length l, typically less than 20 mm, and houses acoustic response tuning means 190.

Sound produced by electroacoustic plasma transducer apparatus 100 can be represented as the combination of two sound sources caused by different physical phenomena. First, sound is produced due to the heat transfer from the ionisation zone to the neutral air particles around the corona electrode 120 and behaves as a monopolar sound source. The heat power H produced at each frequency can be estimated as:

$$H = C ( 3 {U}_{DC}^{2} - 2 {U}_{DC} {U}_{0} ) {u}_{AC}$$

Here, U₀ is the critical voltage at which the corona discharge initiates, C is a dimensional constant. U₀ and C can be identified by measuring the transducer's voltage-current characteristics and approximating it with formula I=CU(U−U₀), where I and U are total current and voltage respectively. The second dipolar source is linked to the electromechanical force F and is transmitted from accelerated ions to the neutral air particles and directed from the corona electrode 120 to the collector electrode 130:

$$F = \frac{Cd}{{μ}_{i}} ( 2 {U}_{DC} - {U}_{0} ) {u}_{AC}$$

where μᵢ is the effective mobility of ions.

With these sound sources, the corresponding pressures close in front of the electroacoustic plasma transducer apparatus 100 at distance x from the centre of the plasma electrode arrangement 110 can be calculated:

$${p}_{F} ( x ) = \frac{1}{2 S} {e}^{jkx} ( 1 - {Re}^{- 2 jkl} ) F$$

$${p}_{H} ( x ) = \frac{c}{2 {C}_{P} {T}_{0} S} {e}^{jkx} ( 1 + {Re}^{- 2 jkl} ) H$$

In the formulas above, S is the total cross-section of the electroacoustic plasma transducer apparatus's plasma electrode arrangement 110 that has a longitudinal separation of distance d, C_{P} is the capacity of heat per unit mass, T₀ is the ambient temperature, R is the complex reflection coefficient from the enclosure, c is the sound speed in the air, k is the wavenumber.

In a majority of the active noise reduction applications envisaged for the electroacoustic plasma transducer apparatus, its compact construction is desirable and thus a small distance l is needed, preferably not greater than 20 mm. In this case, with rigid termination of the enclosure (reflection coefficient R is close to 1), mostly the monopolar pressure p_{H} controls the acoustic field at low frequencies since the pressure p_{F} is attenuated due to its dipolar nature.

In the preferred embodiment of the electroacoustic plasma transducer apparatus 100, the magnitude of acoustic pressure created by the source F is 3-4 times stronger than pressure from the source H. The acoustic response of the electroacoustic plasma transducer apparatus 100 can be optimised in the target frequency range for improving the performance of the active noise reduction system 10, more specifically using an impedance control technique in accordance with the methods described in patent application US2023020879 (A1). The approach of tuning the combination of the enclosure's back wall distance l and back wall properties defined in general by reflection coefficient R allows modifying the electroacoustic plasma transducer apparatus acoustic response. For example, the total produced sound pressure p_{H}+p_{F} can be maximized in a particular frequency range. Fixing back wall distance l defines the frequency-dependent behaviour of the reflection coefficient R. Such an approach of desired enclosure property identification can serve as an approximate guideline for the construction of the electroacoustic plasma transducer apparatus' enclosure design. It can be combined with an experimental approach. With reference to this acoustic response tuning means can be provided in the form of an acoustically absorbent structure 192 formed from porous material. Acoustically absorbent structure 192 may be operative to absorb sound above a low-frequency threshold (e.g. above around 300 Hz).

With reference to FIGS. 11A and 11B, acoustic response tuning means 190 may alternatively be configured to absorb sound at low frequency (e.g. under around 300 Hz).

In one embodiment, the acoustic response tuning means may comprise a combination of an acoustically absorbent structure and a passive resonator 196. FIG. 11A shows an example of an electroacoustic plasma transducer apparatus with enclosure which comprises a passive (radiator or) resonator 196 damped by a porous material 194 with two vents 198.

FIG. 11B shows an example of an electroacoustic plasma transducer apparatus with the enclosure which comprises a passive radiator 196 mounted instead of a back wall.

FIGS. 4A-E show an alternative plasma electrode arrangement 110′ for use in the electroacoustic plasma transducer apparatus 100 of FIG. 1.

Plasma electrode arrangement 110′ is based on plasma electrode arrangement 110 (features in common are labelled according) with corona electrode wires 122 replaced by elongate corona electrode rods 122′. As shown, each corona electrode rod 122′ supports a row of longitudinally extending pins 124 having tapered tips 124A spaced from collector electrode 130′ by distance d.

In this example, the 1.085d≤c≤2d condition is satisfied along the second transverse axis BB by spacing the laterally outermost corona electrode rods 122′ from an inner surface 152′ of the peripheral frame 150′ by a lateral distance b, wherein b=0.45 d.

Along the first transverse axis AA, the condition is satisfied by spacing the tapered tips 124A of the longitudinally extending pins 124 that are closest to the inner surface 152′ of the peripheral frame 150′ (i.e. the opposed outermost pins of each row) by the same distance b. As a consequence, collector electrode 130′ is permitted a uniformly planar surface all the way up to the peripheral frame 150′ along both axes AA and BB.

FIGS. 5A-E show an alternative plasma electrode arrangement 110″ for use in the electroacoustic plasma transducer apparatus 100 of FIG. 1.

Plasma electrode arrangement 110′ is based on plasma electrode arrangement 110 (features in common are labelled according) with corona electrode wires 122 replaced by elongate corona electrode rods 122″ each supporting a single a longitudinally extending elongate blade 124′ (e.g. elongate in the first transverse axis AA) having an extended blade tip 124A′ spaced longitudinally from collector electrode 130′ by distance d. As illustrated, each longitudinally extending elongate blade 124′ has a tapered end profile 124B such that the extended blade tip 124A′ is spaced inwardly relative to the base of the longitudinally extending elongate blade 124′.

In this example, the 1.085d≤c≤2d condition is satisfied along the second transverse axis BB by again spacing the laterally outermost corona electrode rods 122″ from an inner surface 152″ of the peripheral frame 150″ by a lateral distance b, wherein b=0.45d.

Along the first transverse axis AA, the condition is satisfied by spacing the opposed ends of the longitudinally extending elongate blade 124′ from the peripheral frame 150″. Specifically, the opposed ends of the longitudinally extending elongate blade 124′ from the peripheral frame 150″ are positioned such that ends of the extended blade tip 124A′ are spaced from the inner surface 152″ of the peripheral frame 150″ by the same distance b. By virtue of the spacing of the longitudinally extending elongate blades 124′ along the first transverse axis AA, collector electrode 130″ is permitted a uniformly planar surface all the way up to the peripheral frame 150″ along both axes AA and BB.

FIGS. 6A-E show an alternative plasma electrode arrangement 110′″ for use in the electroacoustic plasma transducer apparatus 100 of FIG. 1.

Plasma electrode arrangement 110′″ is based on plasma electrode arrangement 110 (features in common are labelled according) with corona electrode wires 122′″ retained and collector electrode plate 132 replaced by a plurality of parallel elongate collector electrode rods 136. Elongate collector electrode rods 136 are equally spaced laterally by distance a (i.e. the same lateral spacing as the corona electrode wires 122′″). In addition, elongate collector electrode rods 136 are laterally offset relative to corona electrode wires 122′″ by a/2 whereby spacing d between corona electrode 120′″ and collector electrode 130′″ is achieved with a longitudinal spacing less than d.

In this example, the 1.085d≤c≤2d condition is satisfied along the second transverse axis BB by spacing the laterally outermost corona electrode wires 122′″ from the inner surface 152′″ of the peripheral frame 150′″ by a lateral distance b. Laterally outermost elongate collector electrode rods 136 are also spaced from the inner surface 152′″ of the peripheral frame 150′″ thereby allowing values of b to be lower than in the previously illustrated embodiments.

Along the first transverse axis AA, the condition is satisfied by providing collector elongate collector electrode rods 136 with curved end profiles 138 configured such that the distance between corona electrode wires 122′″ and elongate collector electrode rods 136 in the central active area of the corona electrode is d and the path between any point of corona electrode wires 122′″ and any point of the collector electrode 130′″ via the peripheral frame at the region where the corona electrode wires 122′″ meet the peripheral frame 150′″ is equal to c. As illustrated, the curvature of the curved end profiles 138 start at a lateral distance of around b from the inner 152′″ surface of peripheral frame 150′″.

FIGS. 7A-E show an alternative plasma electrode arrangement 110″″ for use in the electroacoustic plasma transducer apparatus 100 of FIG. 1.

Plasma electrode arrangement 110″″ is based on plasma electrode arrangement 110 (features in common are labelled according) with a modified form of corona electrode wires 122″″ retained and collector electrode plate 132″″ retained in a uniformly planar form.

In this example, the 1.085d≤c≤2d condition is satisfied along the second transverse axis BB by spacing the laterally outermost corona electrode wires 122″″ from the inner surface 152″″ of the peripheral frame 150″″ by a lateral distance b.

Along the first transverse axis AA, the condition is satisfied by providing corona electrode wires 122″″ with curved end profiles 126 supported by opposed outer rods 128. Curved end profiles 126 are configured such that the distance between corona electrode wires 122″″ and collector electrode plate 132″″ in the central active area of the corona electrode is d and the path between any point of corona electrode wires 122″″ and any point of the collector electrode 130′″ via the peripheral frame at the region where the corona electrode wires 122″″ meet the peripheral frame 150″″ is equal to c. As illustrated, the curvature of the curved end profiles 126 start at a lateral distance of around b from the inner 152″″ surface of peripheral frame 150″″.

FIG. 8A-E show an alternative ANR system 10′ based on ANR system 10 (features in common are labelled accordingly) in which collector electrode 130 and outer ozone filter 180 are replaced by collector electrode 130′″″ including ozone reducing material.

Collector electrode 130′″″ comprises a foraminous filter/electrode plate 132′″″ with honeycomb structure with openings facing the plasma electrode arrangement. Foraminous filter/electrode plate 132′″″ has a similar inner profile to collector electrode 130 (including curved end profiles 134′) but a greater longitudinal thickness (e.g. 5-15 mm) and smaller aperture size/increase aperture density (e.g. with an average effective aperture diameter of between 0.1 and 2 mm and an aperture density of greater than 30 apertures per cm²).

An ozone reducing catalyst (e.g. manganese oxide-based catalyst) is provided on (e.g. within or applied as a coating to) the porous structure. In one embodiment, filter/electrode plate 132′″″ is a foraminous metal plate (e.g. steel or aluminium plate) and the ozone reducing catalyst is applied as a coating to outer surfaces of the plate other than the inner (electrode) surface of the plate (e.g. external outer surface of the plate and internal surfaces of the apertures).

The inner surface of the plate is generally not coated in order to avoid any reduction in electrical conductivity of the collector electrode. Collector electrode 130′″″ is removably coupled to peripheral frame 150′″″ to allow replacement of the collector electrode (e.g. with suitable electrical connections provided to allow the outer electrode to be electrically disconnected).

FIGS. 9A-E show another alternative ANR system 10″ based on ANR system 10 (features in common are labelled accordingly) in which acoustic response tuning means 190 is replaced by internal porous structure 190″ and outer ozone filter 180 is replaced by airflow blocking screen 250 provided in front of the plasma electrode arrangement 110″″″.

Internal porous structure 190″ has a similar honeycomb aperture structure to foraminous filter/electrode plate 132″″ of FIGS. 8A-E and is configured to absorb sound above a low-frequency threshold (e.g. above around 300 Hz).

An ozone reducing catalyst (e.g. manganese oxide-based catalyst) is provided on (e.g. within or applied as a coating to) the internal porous structure 190″. In one embodiment, internal porous structure 190″ is a foraminous metal plate (e.g. steel or aluminium plate) and the ozone reducing catalyst is applied as a coating to outer surfaces of the plate (e.g. outer surface of the plate and internal surfaces of the apertures). Internal porous structure 190″ may removably coupled to peripheral frame 150″″″ to allow replacement of the internal porous structure.

Airflow blocking screen 250 is operative to substantially allow transmission of acoustic pressure waves but substantially prevent transmission of airflow. Airflow blocking screen 250 is formed from a porous sheet material 252 (e.g. wire mesh or textile material) and has a longitudinal thickness of less than 5 mm.

In one embodiment, the airflow blocking screen 250 has an acoustic power transmission coefficient greater than 50% in the frequency range 0-5000 Hz.

In one embodiment, the airflow blocking screen 250 has an acoustic power reflection coefficient no higher than 10% over a frequency range 0-5000 Hz.

FIG. 10 shows a further ANR system 10′″ based on ANR system 10 (features in common are labelled accordingly) in which sensing microphone 200 is replaced by a pair of sensing microphones 200A, 200B. Sensing microphone 200A operates as an outer sensing microphone for monitoring a pressure p₁ in front of the outer ozone filter 180. Sensing microphone 200B operates as an inner sensing microphone for monitoring a pressure p₂ between the outer ozone filter 180 and the plasma electrode arrangement 110.

In one embodiment, outer ozone filter has a resistance Res and the ANR circuitry is operative to determine an estimate of airflow velocity Vₑₛₜ, wherein

$${V}_{est} = \frac{p 1 - p 2}{Res} .$$

1. An electroacoustic plasma transducer system comprising:
electroacoustic plasma transducer apparatus comprising:
a plasma electrode arrangement including a corona electrode and a collector electrode separated from the corona electrode by an air gap;
a peripheral support operative to support the plasma electrode arrangement, the peripheral support being electrically insulative; and
an enclosure defining a chamber for receiving rearward radiation from the plasma electrode arrangement; and
drive circuit operative to supply a voltage U(t) between the corona electrode and the collector electrode of the electroacoustic plasma transducer apparatus;
wherein the plasma electrode arrangement is configured such that: a central active area of the corona electrode is spaced from the collector electrode by a distance d; and a periphery of the corona electrode is spaced from the collector electrode and/or peripheral support such that for any path from the corona electrode to the collector electrode via the peripheral support, the path has a path length c, wherein c≥1.085d.

2. An electroacoustic plasma transducer system according to claim 1, wherein 1.085d≤c≤2d.

3. An electroacoustic plasma transducer system according to claim 1, wherein d=2-10 mm.

4. An electroacoustic plasma transducer system according to claim 1, wherein the drive circuit is operative to maintain a voltage difference range U(t)range between the corona electrode and collector electrode when in an operative mode, wherein U(t)_{range}=(0.35−0.85)×E_{breakaown}×d, wherein E_{breakaown}=3×106 V/m.

5. An electroacoustic plasma transducer system according to claim 1, wherein the plasma electrode arrangement defines a longitudinal axis along which the corona electrode and collector electrode are spaced and at least one of the corona electrode and the collector electrode is spaced from the peripheral support along an axis transverse to the longitudinal axis by a distance b satisfying the requirement for c.

6. An electroacoustic plasma transducer system according to claim 1, wherein at least one of the corona electrode and the collector electrode have longitudinally extending inclined end profiles whereby spacing between the corona electrode and the collector electrode at the region where the plasma electrode arrangement meets the peripheral support satisfies the requirement c.

7. An electroacoustic plasma transducer system according to claim 1, wherein the corona electrode is a panel-form collector electrode coupled to the peripheral support.

8. An electroacoustic plasma transducer system according claim 1, wherein the corona electrode comprises a plurality of elongate corona electrode members coupled to the peripheral support, each of the plurality of elongate corona electrode members substantially extending along a first transverse axis of the plasma electrode arrangement.

9. An electroacoustic plasma transducer system according to claim 1, wherein the corona electrode supports at least one projecting portion projecting along the longitudinal axis towards the collector electrode.

10. An electroacoustic plasma transducer system according to claim 9, wherein the at least one projecting portion is spaced from the peripheral support relative the first transverse axis by a minimum distance b.

11. An electroacoustic plasma transducer system according to claim 9, wherein the at least one projection has a tapered profile defining a leading surface that is spaced from the support relative the first transverse axis by the minimum distance b.

12. An electroacoustic plasma transducer system according to claim 9, wherein b=0.45d.

13. An electroacoustic plasma transducer system according to claim 1, wherein the collector electrode is a panel-form collector electrode.

14. An electroacoustic plasma transducer system according to claim 1, wherein the collector electrode comprises a plurality of elongate collector electrode members coupled to the peripheral support.

15. An electroacoustic plasma transducer system according to claim 1, wherein the electroacoustic plasma transducer apparatus further comprises an acoustic response tuning structure provided in or as part of the enclosure.

16. An electroacoustic plasma transducer system according to claim 15, wherein the acoustic response tuning structure comprises an acoustically absorbent structure provided in the chamber.

17. An electroacoustic plasma transducer system according to claim 15, wherein the acoustic response tuning structure comprises a passive resonator.

18. An electroacoustic plasma transducer system comprising:
electroacoustic plasma transducer apparatus comprising:
a plasma electrode arrangement including an inner electrode and an outer electrode separated from the inner electrode by an air gap;
a peripheral support operative to support the plasma electrode arrangement; and
an enclosure defining a chamber for receiving rearward radiation from the plasma electrode arrangement; and
drive circuit operative to supply a voltage U(t) between the corona electrode and the collector electrode of the electroacoustic plasma transducer apparatus;
wherein the electroacoustic plasma transducer apparatus further comprises an ozone reducing material.

19. An electroacoustic plasma transducer system according to claim 18, wherein the electroacoustic plasma transducer apparatus comprises a porous structure and the ozone reducing material is provided on the porous structure.

20. An electroacoustic plasma transducer system according to claim 18, wherein the porous structure comprises an outer ozone filter provided in front of the plasma electrode arrangement.

21. An electroacoustic plasma transducer system according to claim 18, wherein the outer electrode defines an inner face facing the inner electrode, an outer face substantially opposed to the inner face, and internal surfaces defined by apertures in the outer electrode, wherein the ozone reducing material is applied to the internal surfaces of the outer electrode and/or the outer face of the outer electrode.

22. An electroacoustic plasma transducer system according to claim 21, wherein the ozone reducing material is substantially not applied to the inner face of the outer electrode.

23. An electroacoustic plasma transducer system according to claim 21, wherein the outer electrode is removably coupled to the peripheral support.

24. An electroacoustic plasma transducer system according to claim 19, wherein the ozone reducing material is provided within the enclosure.

25. An electroacoustic plasma transducer system according to claim 24, wherein the electroacoustic plasma transducer apparatus further comprises an airflow blocking screen provided in front of the plasma electrode arrangement, wherein the airflow blocking screen is operative to substantially allow transmission of acoustic pressure waves but substantially prevent transmission of airflow.

26. An electroacoustic plasma transducer system according to claim 24, wherein the porous structure is provided within the chamber.

27. An active noise reduction (ANR) system comprising:
electroacoustic plasma transducer system in accordance with claim 1;
at least one acoustic sensor; and
ANR circuitry operative to receive a signal from the at least one acoustic sensor and control an output of the electroacoustic plasma transducer system to reduce noise.
